(19) United States
(12) Patent Application Publication
(10) Pub. No.: US 2016/0060915 A1
(43) Pub. Date: Mar. 3, 2016

(54) Door Latch

(71) Applicant: DEKA Products Limited Partnership, Manchester, NH (US)

(72) Inventors: Benjamin W. Jones, JR., Salisbury, NH (US); Jacob W. Scarpaci, Manchester, NH (US); James D. Dale, Nashua, NH (US); James M. Sibona, Hooksett, NH (US)

(21) Appl. No.: 14/839,428

(22) Filed: Aug. 28, 2015

Related U.S. Application Data
(60) Provisional application No. 62/043,879, filed on Aug. 29, 2014.

(51) Int. Cl. E05C 3/00; E05C 3/12

(52) U.S. Cl. CPC E05C 3/002; E05C 3/124

(57) ABSTRACT

A rotatable door latch for a door hingedly attached the housing of a device, which in some embodiments may be a medical device for handling fluids, such as a peritoneal dialysis cycler with pump cassette. In an embodiment, the door is configured to close over an installed cassette against a front panel of the housing, the door latch configured to capture the head of a post mounted to the housing. After capturing the head of the post and rotating the door latch, a slot in the latch flanked by a ramp or cam feature slides against the post head, the ramp increasing in thickness to progressively increase the closing force between the door and the post head. Upon full closure of the door latch, a detent at the end of the slot provides a maintenance closing force between the door and the post head. The thickness of at least a portion of the detent is less than the terminal thickness of the ramp, so that a release force needed to move the detent off the post head is greater than the maintenance force between the detent and the post head.

### CROSS REFERENCE TO RELATED APPLICATIONS

This application claims the benefit of U.S. Provisional Patent Application Ser. No. 62/043,879, filed Aug. 29, 2014 and entitled Door Latch (Attorney Docket No. M78), which is incorporated herein by reference in its entirety.

### FIELD OF THE INVENTION

The present disclosure relates generally to door latches used to secure the closure of a door of an apparatus. More specifically, the present disclosure relates to latching mechanisms that inhibit unintended or improperly timed attempts to open a closed door of a device.

### BACKGROUND

In some cases, opening the door of a device may involve manipulating a handle so as to engage a latch to close the door securely to the device and to disengage the latch when opening the door, allowing the door to be pulled to an open position. In some circumstances, an operator may inadvertently manipulate or accidentally jostle the handle causing the door to swing open. In other situations, an operator may purposefully attempt to open the door at an inopportune time when it should remain closed (e.g., while the device is operating). This may be particularly significant, for example, in a fluid delivery device such as a medical device in which the door may be maintaining various fluid seals in a fluid handling system such as a pump and valve cassette bounded by a flexible membrane. In many existing devices, the door latching mechanism may secure the closure of a door when the device is operating in a manner that is too easily defeated by the use of relatively moderate force on the handle of the latching mechanism. Therefore, a need exists for a door latch that inhibits inadvertent or poorly timed opening of a door while also not excessively inhibiting a user's ability to open the door of the device when it is not operating.

### SUMMARY OF THE INVENTION

A door latch may comprise a latch body pivotally connected to a door that is hingedly attached to a housing. The latch body is configured to rotate about an axis perpendicular to a face of the door. The latch body comprises a hole having a first width through which a post attached to the housing penetrates as the door is closed. The latch body comprises an elongated slot having a first end and a second end, the slot having a width smaller than the width of the hole, and extending from the first end at the hole to the second end, so that rotation of the latch body about its axis to a closing position moves the slot relative to the post from the first end to the second end of the slot. The post has a head sized larger than a neck or body of the post, the head being smaller than the width of the hole but larger than the width of the slot. The neck or body of the post is sized to fit through the slot, so that the post head is captured by the slot as the latch body rotates to the closing position. The slot is flanked by a ramp or cam element on the latch body that provides a closing force between the door and the post as the latch body is rotated to the closing position. The camming effect of the ramp or cam element is generated by having a first thickness at the first end of the slot, progressing to a second greater thickness at the second end of the slot. The second end of the slot terminates at a slotted detent having a thickness that provides a maintenance force between the door and the post when the detent is rotated onto the head of the post. The ramp or cam element at the second end of the slot reaches a terminal thickness greater than the thickness of the detent, thereby requiring a greater force between the door and the post than the maintenance force in order to rotate the detent onto or off the head of the post. This difference in force is magnified when the door is closed and being pressed against the housing by a pressurized piston in the door.

A portion of the detent adjacent the terminal portion of the slot may gradually increase in thickness to meet the terminal thickness of the slot, in order to permit the post head to engage the slot with reduced wear on the components (latch body and post). This transition may comprise a graduated slope that is straight or curved. The slot of the door latch may define a curved or arcuate path as the latch body is rotated about its axis. In some embodiments, the curved or arcuate path may define a rotation of the slot about a fixed radius extending to the axis of rotation of the latch body. The latch body may comprise a handle by which a user can rotate the latch body to a closing or open position. In an embodiment, the post head may have a rounded, conical or triangular shape to facilitate penetration of the head of the post through the hole of the latch body.

A door closing system for a medical device may comprise a rotatable latch mounted to a door hingedly connected to a housing of the medical device, so that the axis of rotation of the latch is generally perpendicular to the face of the door. The system comprises a post fixed to the housing of the medical device and facing an inner side of the door as the door is closed. The post is configured to penetrate a hole in the latch upon closure of the door. The latch further comprises an elongated slot extending from the hole to a slotted detent of the latch. A head of the post is small enough to penetrate the hole, but larger than the width of the slot, while a neck or body of the post is small enough to pass through the slot, so that the head of the post can be captured by the slot as the latch is rotated from an open position to a closed position. The slot is flanked by a ramp or cam element on the latch body that provides a closing force between the door and the post as the latch body is rotated to the closing position. The camming effect of the ramp or cam element is produced by having a first thickness at the first end of the slot, progressing to a second greater thickness at the second end of the slot. The second end of the slot terminates at a slotted detent having a thickness that provides a maintenance force between the door and the post when the detent is rotated onto the head of the post. The ramp or cam element at the second end of the slot reaches a terminal thickness greater than the thickness of the detent, thereby requiring a greater force between the door and the post than the maintenance force in order to rotate the detent onto or off the head of the post. This difference in force is increased when the door is closed and being pressed against the housing by a pressurized piston in the door. The piston may be pressurized by an inflatable bladder in the door behind the piston.

A portion of the detent adjacent the terminal portion of the slot may gradually increase in thickness to meet the terminal thickness of the slot, in order to permit the post head to engage the slot with reduced wear on the components (e.g., latch and post). This transition may comprise a graduated slope that is straight or curved. The slot of the door latch may define a curved or arcuate path as the latch is rotated about its axis. In some embodiments, the curved or arcuate path may define a rotation of the slot about a fixed radius extending to the axis of rotation of the latch. The latch may comprise a handle by which a user can rotate the latch to a closing or open position. In an embodiment, the post head may have a rounded, conical or triangular shape to facilitate penetration of the head of the post through the hole of the latch body.

### BRIEF DESCRIPTION OF THE DRAWINGS

FIGS. 1-2 show an example embodiment of a device including a cassette receiving section or receptacle;

FIG. 3 shows an example embodiment of a pneumatic actuator module;

FIGS. 4A-4B show an exploded view of the example embodiment of the pneumatic actuator module shown in FIG. 3;

FIG. 5 depicts an example partial view of the device showing the pneumatic actuator module in its assembled position.

FIGS. 6A-6B show cross-sectional views of an example pneumatic actuator module taken at line 6-6 of FIG. 3;

FIGS. 7A-7C show an example representational view of a cam feature which may be included in a door latch;

FIG. 8 shows a top down view of an example door latch; and

FIG. 9 shows a perspective view of an example door latch.

FIGS. 10A-10C show an example representational view of a cam feature that include a mechanical interference element which may be included in a door latch;

FIG. 11 shows a top down view of an example door latch;

FIG. 12 shows a perspective view of an example door latch; and

FIG. 13 shows an example representational view of a cam feature that includes an alternate embodiment of a mechanical interference element.

### DETAILED DESCRIPTION

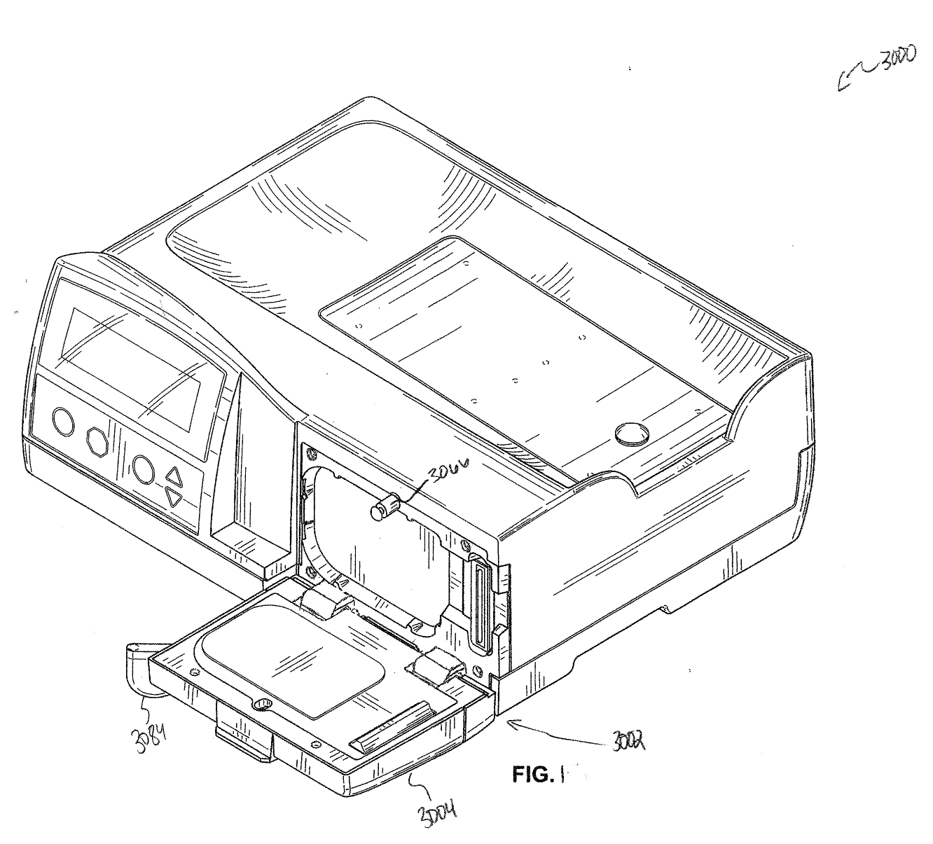

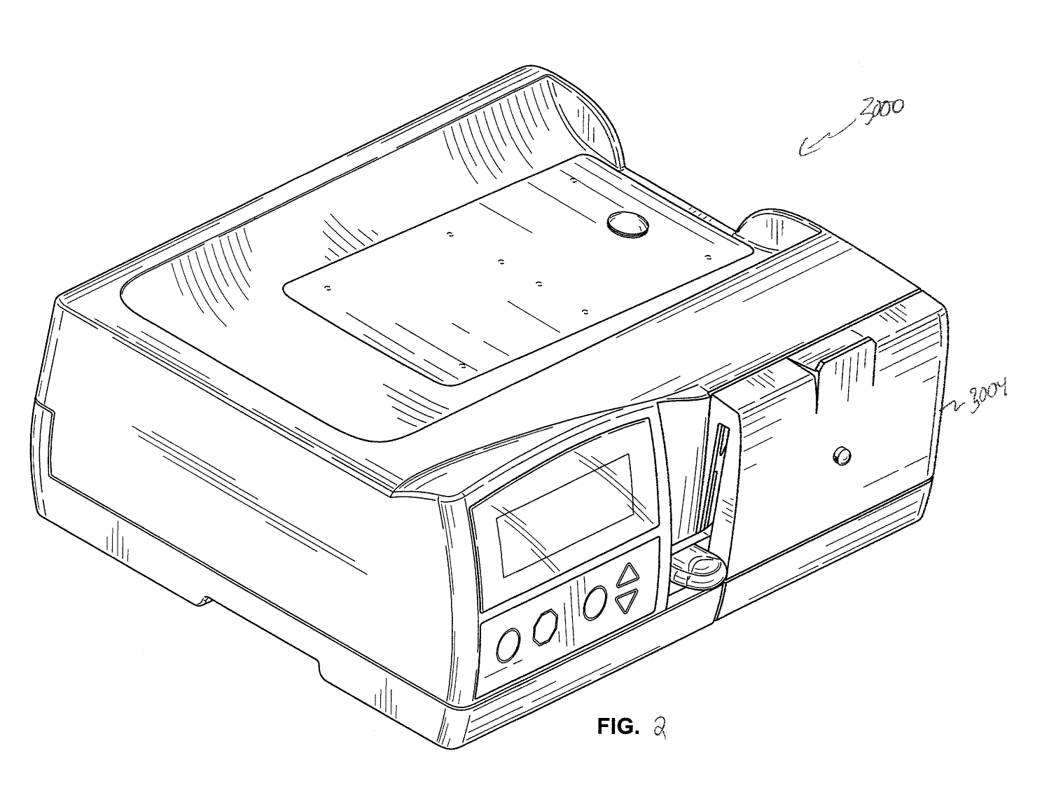

As shown in FIG. 1 and FIG. 2 an embodiment of a device 3000 which includes a cassette receiving section or receptacle 3002 is depicted. The cassette itself is not shown in FIG. 1 and FIG. 2. In the example embodiment shown in FIGS. 1-2, the device 3000 is a medical device, specifically a peritoneal dialysis machine, though the disclosed invention is not limited to peritoneal dialysis machines. For example, the device may be any other type of dialysis machine, infusion pump, other medical device, or non-medical fluid delivery device that uses a pump cassette enclosable by a door of the fluid delivery device.

The example device 3000 includes a door 3004 pivotally or hingedly attached to a cassette housing 3006. A cassette receiving section or receptacle 3002 includes the door 3004 and various components of the device assembly 3006.

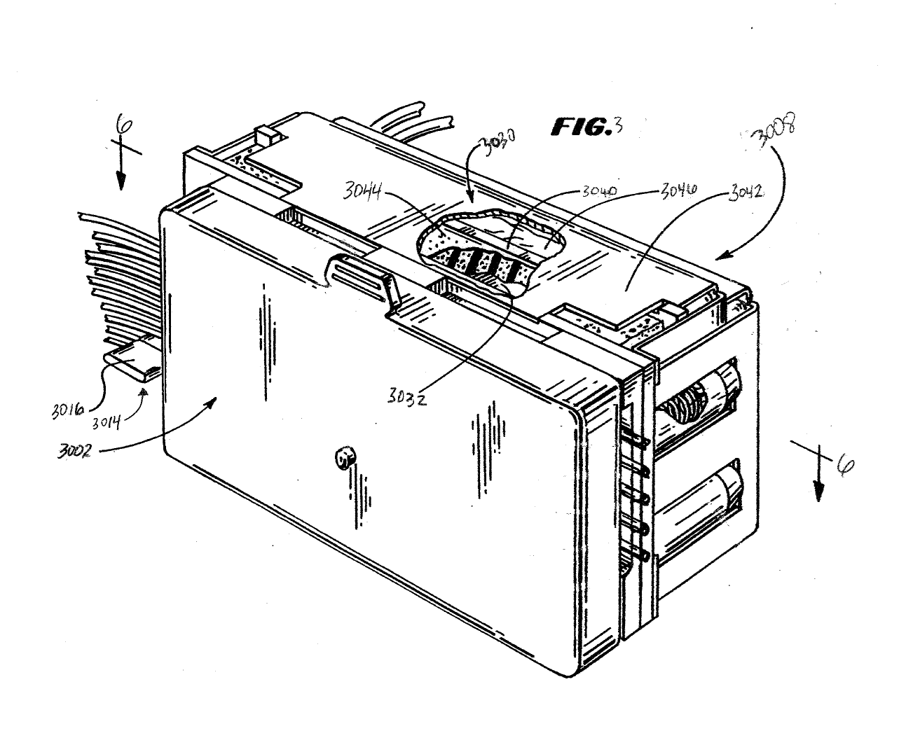

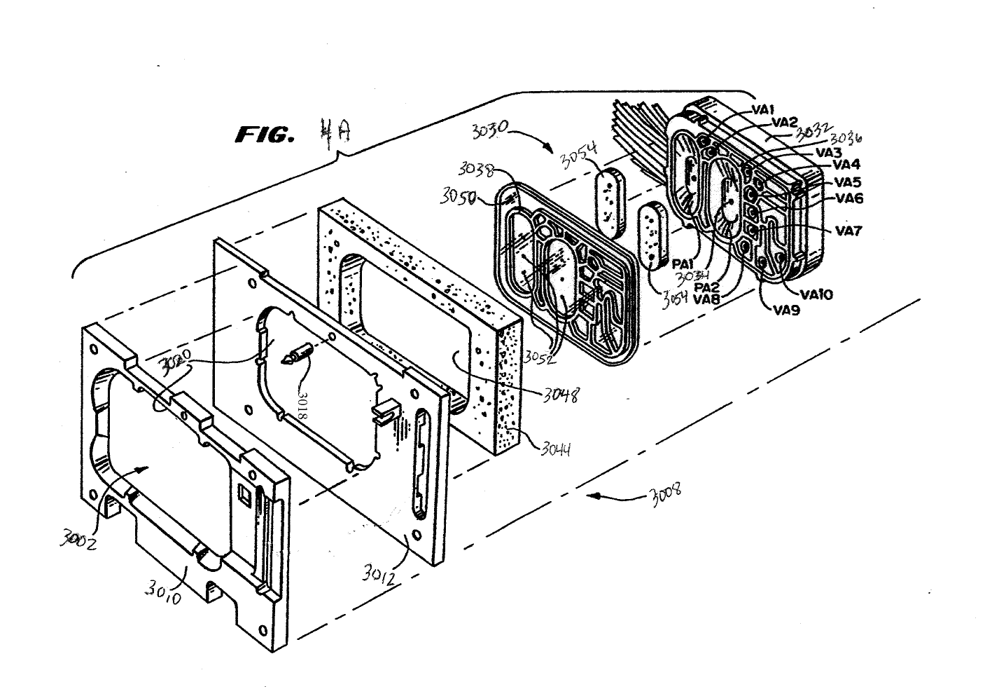

Referring now also to FIGS. 3-4B, in a peritoneal dialysis machine or cycler, a cassette receiving section 3002 forms a part of a pneumatic actuator module 3008. A pneumatic actuator module 3008 may, among other things, be used to pump fluid through an installed cassette, create fluid seals in the cassette, actuate valves or pumps in the cassette, occlude flow to or from the cassette, and aid in maintaining the latched door 3004 in a securely closed position.

The pneumatic actuator module 3008 also includes a front plate 3010 joined to a back plate 3012. The front and back plates 3010 and 3012 collectively form a block with an interior recess 3020. A door 3004 is hinged to the front plate 3010. To retain the door 3004 in a closed position, the door 3004 includes a door latch 3014. The door latch 3014 may be operated by a latch handle 3016. When the door 3014 is closed and the latch handle 3016 has been moved into a latched position, a portion of the door latch 3014 engages a latch pin or post 3018 to lock or latch the door 3004 in place. In an embodiment, moving the latch handle 3016 to the latched position involves displacing the latch handle 3016 downward after closing the door 3014. This causes the latch 3014 to engage the pin 3018 and thus lock the door 3004. Moving the latch handle 3016 upward when the door 3004 is closed and locked acts to release the latch 3014 from the pin 3018. This allows the door 3004 to be opened to gain access to the cassette receiving section 3002. In other embodiments, the direction of movement for latch actuation may differ. The latching mechanism may also help to prevent undesired opening of the door 3004 during therapy or when cassette 3022 seals are being maintained.

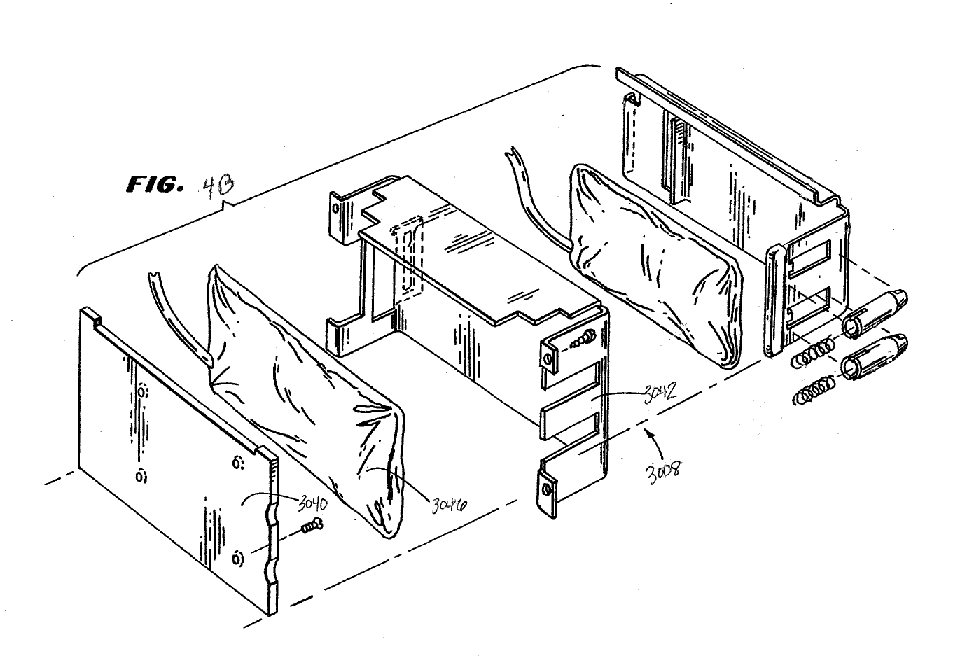

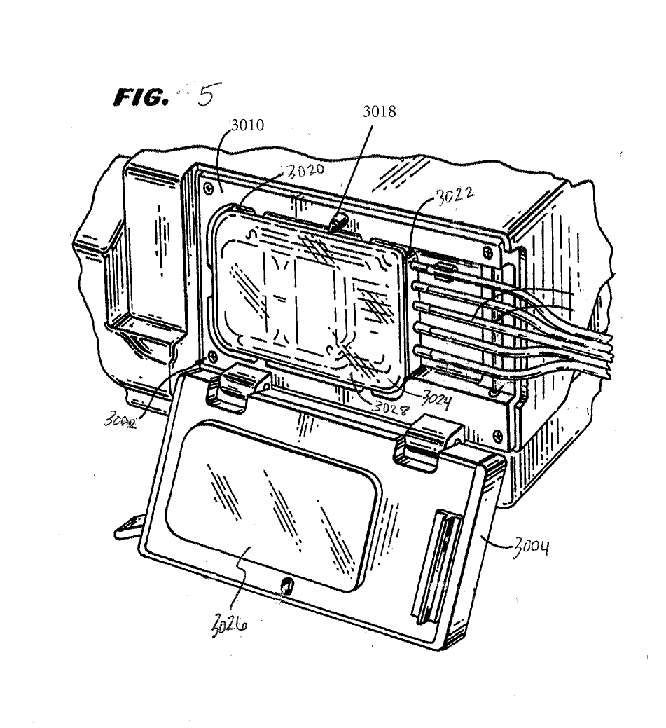

With the door 3004 opened, a user can insert a cassette 3022 (e.g. as shown in FIG. 5) into the interior recess 3020 of the cassette receiving section. The cassette 3022 may be inserted such that its front side faces the interior of the device 3000. The interior face of the door 3004 may include a raised portion 3026 positioned to be in opposition to the recess 3020 when the door is closed. Closing the door 3004 brings the raised portion 3026 into contact with a diaphragm or membrane 3028 on the back side 3024 of an installed cassette 3022. In some embodiments, the raised portion 3026 may be a gasket or have an elastomeric surface.

The pneumatic actuator module 3008 shown in FIGS. 4A and 4B includes a piston head assembly 3030 located behind the back plate 3012. The piston head assembly 3030 may include a moveable member or piston element 3032. As in FIG. 4A, the piston element 3032 may include a rigid plate which is a molded or machined plastic or metal body. The body comprises a number of pump actuators and a number of valve actuators. In an example embodiment shown, the body contains two pump actuators PA1 and PA2 and ten valve actuators VA1 to VA10. The pump actuators PA1/PA2 and the valve actuators VA1 to VA10 are oriented ane arranged to mate with the pump stations and valve stations on the front side of the cassette 3022.

Each actuator PA1/PA2/VA1 to VA10 includes a port 3034. Each port 3034 allows fluid communication from one side of the piston element 3032 to the other. The ports 3034 are configured to convey positive or negative pneumatic pressures from a pneumatic pressure distribution module or pneumatic circuit.

As FIG. 4A shows, the piston element 3032 includes a number of grooves 3036 formed in the piston element 3032 to surround the pump and valve actuators PA1/PA2/VA1 to VA10. A gasket 3038 or piston cover included in the pneumatic actuator module 3008 includes cooperating ribs arranged to fit into these grooves 3036. The gasket 3038 seals the peripheries of the actuators PA1/PA2/VA1 to VA10 against pneumatic pressure leaks. The opposite face of the gasket 3038 serves to contact a cassette 3022 when a cassette 3022 is installed in the interior recess 3020.

The configuration of the gasket 3038 follows the pattern of raised edges or walls that peripherally surround and separate the pump chambers and valve stations on the front side of the cassette 3022.

The piston element 3032 is attached to a pressure plate 3040 within the pneumatic actuation module 3008. The pressure plate 3040 is, in turn, retained within a frame 3042 also included in the pneumatic actuation module 3008. The frame 3042 allows for and/or serves to guide movement of the pressure plate 3040 and attached piston element 3032 within the pneumatic actuation module 3008.

The side of the pressure plate 3040 that carries the piston element 3032 abuts against a resilient spring element 3044 which is included within the frame 3042. The spring element 3044 may, for example, be made of an open cell foam material. The frame 3042, in the example embodiment, also supports an inflatable bladder 3046. The inflatable bladder 3046 is disposed such that it contacts the other side of the pressure plate 3040.

The spring element 3044 may be configured so that it does not abut against the piston element 3032. In the example embodiment, the piston element 3032 extends through a window 3048 in the spring element 3044. The window 3048 is sized and shaped to substantially match or surround the interior recess 3020 which receives the cassette 3022. With a cassette 3022 positioned in the interior recess 3020 and the door 3004 closed, the piston element 3032 in the window 3048 is aligned with the diaphragm or membrane of the front face or side the cassette 3022.

As FIG. 6A shows, when the inflatable bladder 3046 is relaxed (i.e., not inflated), the spring element 3044 contacts the pressure plate 3040. In this position the spring element 3044 is preferably slightly compressed. The spring element 3044 serves to hold the piston element 3032 away from pressured contact with a cassette 3022 within the interior recess 3020. It may also serve to help constrain the pressure plate 3040 and attached piston element 3032 into a relaxed or non-actuated position when movement would be undesirable.

A pneumatic pressure distribution module is configured to supply positive pneumatic pressure to the inflatable bladder 3046. As FIG. 6B shows, when the inflatable bladder 3046 is inflated, it presses the pressure plate 3040 against the spring element 3044, compressing it. In the example embodiment, the open cell structure of the spring element 3044 resiliently deforms under the pressure. The piston element 3032 displaces within the window 3048 into pressured contact against the cassette diaphragm or membrane 3056 (see FIG. 6A).

When inflated, the inflatable bladder 3046 presses the piston element 3032 against the gasket 3038. This force is exerted against the cassette diaphragm 3056 through the gasket 3038. The inflatable bladder 3046 pressure also presses the back side diaphragm 3028 tightly against the raised portion 3026 on the interior of the door 3004.

As a result, the diaphragms of the cassette 3022 seat against the raised peripheral edges or ribs that surround the cassette pump chambers and valve stations. Thus the pressure applied to the pressure plate 3040 by the inflatable bladder 3046 seals the peripheries of these regions of the cassette 3022 to isolate various fluid pathways and chambers within the cassette 3022.

The piston element 3032 remains in this position as long as the inflatable bladder 3046 retains positive pressure and the door 3004 remains closed. In this position, in the example embodiment, the two pump actuators PA1 and PA2 in the piston element 3032 register with two pump chambers in the cassette 3022. The ten valve actuators VA1 to VA10 in the piston element 3022 likewise register with ten valve stations in the cassette 3022.

A pneumatic pressure distribution module or pneumatic circuit may convey positive or negative pneumatic fluid pressure to the actuators PA1/PA2/VA1 to VA10 as governed by a controller. These positive and negative pressures flex or displace the diaphragm 3056 to operate pump chambers and valve stations in the cassette 3022. This, in turn, moves liquid through the cassette 3022 in a controlled fashion.

The positive pressure in the bladder 3046 may be vented to relieve the pressure applied through the pressure plate 3040 (via the gasket 3038) to the cassette 3022. As a result, the spring element 3044 urges the pressure plate 3040 and attached piston element 3032 away from pressured contact with the cassette diaphragm 3056. In this position, the door 3004 can be opened to unload the cassette 3022 after use.

As FIG. 4A shows, the gasket 3038 may include an integral elastomeric or flexible membrane 3050 spanning or stretched across it. This membrane 3050 may be exposed in the window 3048. It serves as the interface between the piston element 3032 and the diaphragm 3056 of the cassette 3022, when the cassette 3022 is positioned in the interior recess 3020.

The membrane 3050 includes one or more small through holes 3052 in each region overlying the pump and valve actuators PA1/PA2/VA1 to VA10. The holes 3052 are sized to convey pneumatic fluid pressure from the piston element actuators to the cassette diaphragm 3056. In an embodiment, the holes 3052 are small enough to inhibit the passage of liquid. This forms a flexible splash guard across the exposed face of the gasket 3038.

The elastomeric membrane 3050 keeps liquid out of the pump and valve actuators PA1/PA2/VA1 to VA10, should the cassette diaphragm 3056 leak. The elastomeric membrane 3050 also keeps particulate matter out of the pump and valve actuators of the piston element 3032. The elastomeric membrane 3050 can be periodically wiped clean if necessary.

As FIG. 4A shows, inserts 3054 may occupy the pump actuators PA1 and PA2 behind the membrane 3050. In a specific embodiment, the inserts 3054 are made of an open cell foam material. The inserts 3054 help dampen and direct pneumatic pressure upon the membrane 3050. The presence of inserts 3054 may help to distribute pressure more quickly within the pump actuators PA1 and PA2, helping to negate transient thermal effects that may arise during the delivery of pneumatic pressure, and allowing for more accurate determinations of chamber volume changes using standard pressure-volume relationships governed by the ideal gas law.

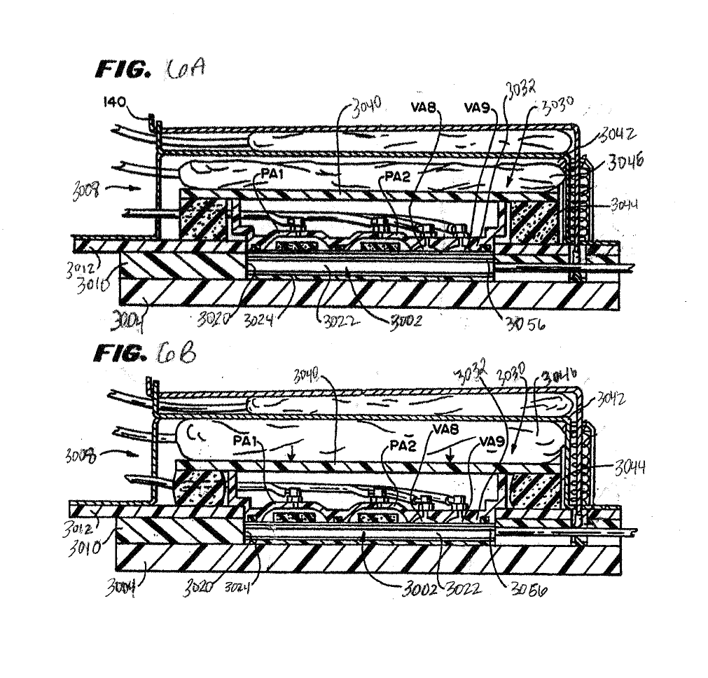

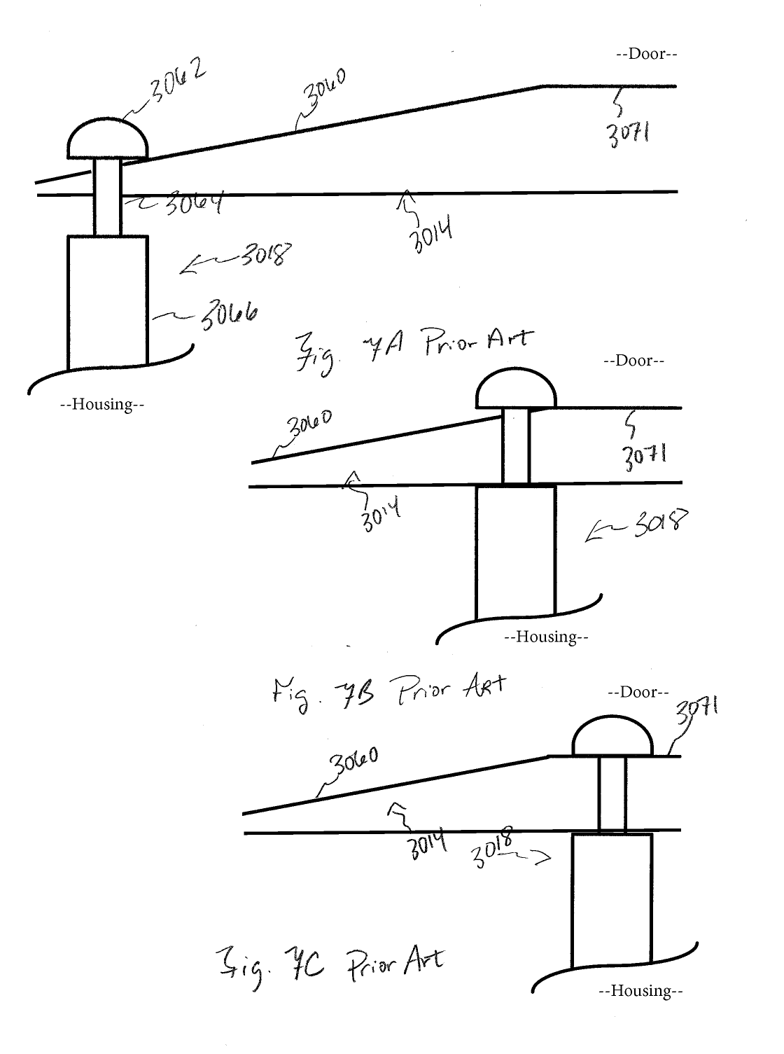

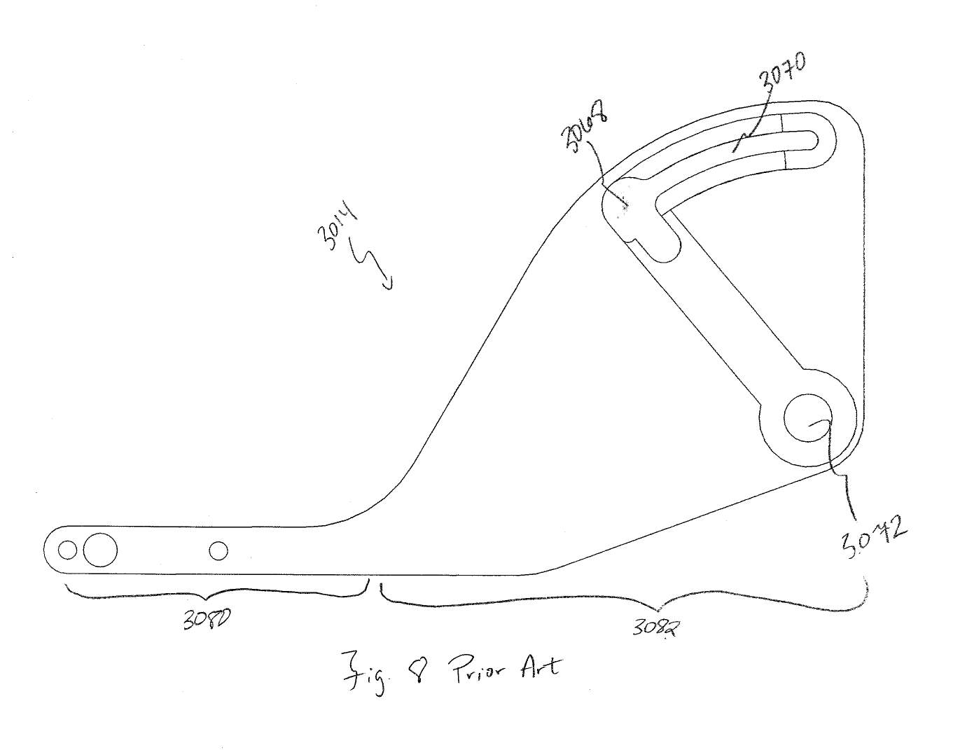

As mentioned above, a door 3004 is hinged to the front plate 3010 and may be swung between an open and a closed position. To retain the door 3004 in the closed position, which is necessary when the device is performing a therapy and/or to maintain various fluid seals in the cassette, the door 3004 includes a latch member or door latch 3014 which may be manually actuated by a user. When the door 3004 is closed and the door latch 3014 has been moved into a latched position, a portion of the door latch 3014 engages a mating latching structure, which in some embodiments may be a latch pin or post 3018, to lock or latch the door 3004 in place. In an embodiment, the door latch 3014 is actuated by rotating a door latch body 3082 about a pivot point or axis. As shown representationally in cross-sectional drawings or prior devices in FIGS. 7A-7C the door latch 3014 includes a ramp 3060. The ramp 3060 acts as a cam feature 3059 (see FIG. 9) incorporated in the door latch 3014. After closing the door and having the door latch engage the head of the pin or post, rotation of the latch to a closed position causes the ramp to slide along the head of the stationary pin or post, progressively tightening the pin or post head against the body of the latch, and thus tightening the door against the front plate of the medical device. As shown, a portion of the latch body progressively increases in thickness to reach a plateau thickness 3071 corresponding to full closure of the latch and door. This is a non-ramped terminal section of the latch body at which the door is fully closed and at which a pre-determined force between the door and post head is maintained. With the post head at this location, pressure may be applied by the door piston to fully engage the door with the front plate of the housing to seal the door against the front plate of the housing.

As also mentioned above, the door latch 3014 may interface with a latch pin or post 3018 which holds the door in the locked position. In a prior embodiment, the latch pin 3018 includes a head 3062, a narrower neck 3064 and a pin body 3066 that may be thicker or the same diameter as the neck. The head 3062 may be approximately the same diameter as the pin body 3066 if the neck is made narrower. In other embodiments, the head 3062 may be smaller or larger than the pin body 3066. The neck 3064 may be of a smaller diameter than each of the head 3062 and pin body 3066 as shown, for example in FIG. 1 or FIG. 5. The pin body 3066 may be attached to a larger device such as a housing surrounding the cassette receiving area, or a front plate 3010, as shown in FIG. 1, FIG. 4A and FIG. 5.

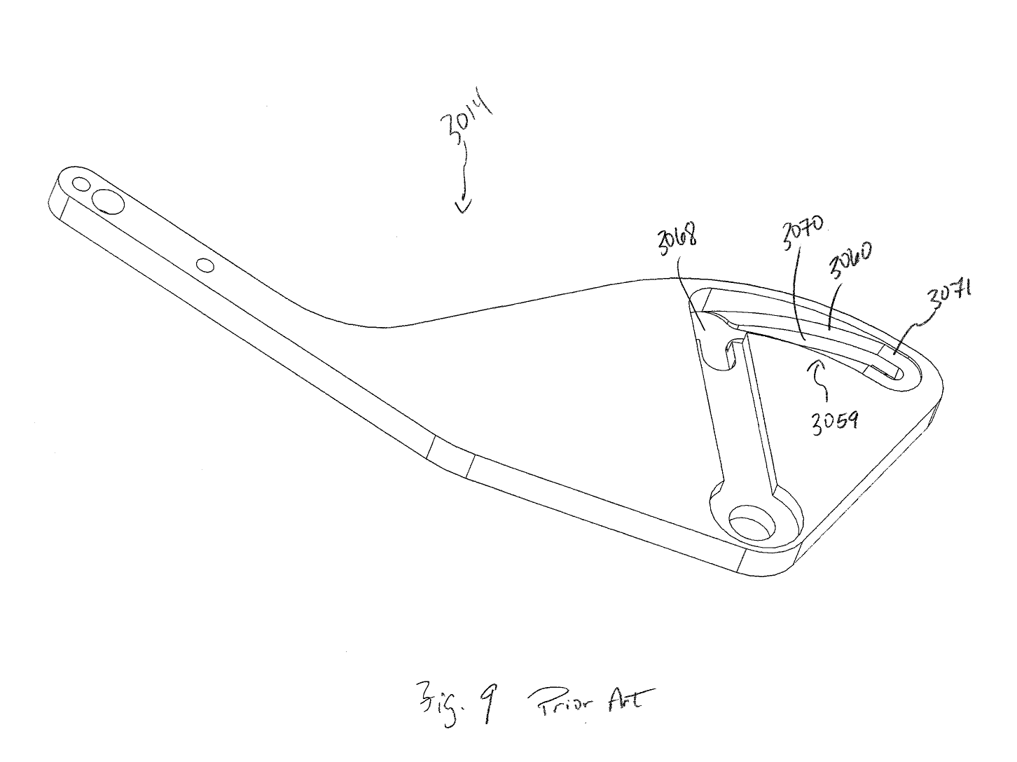

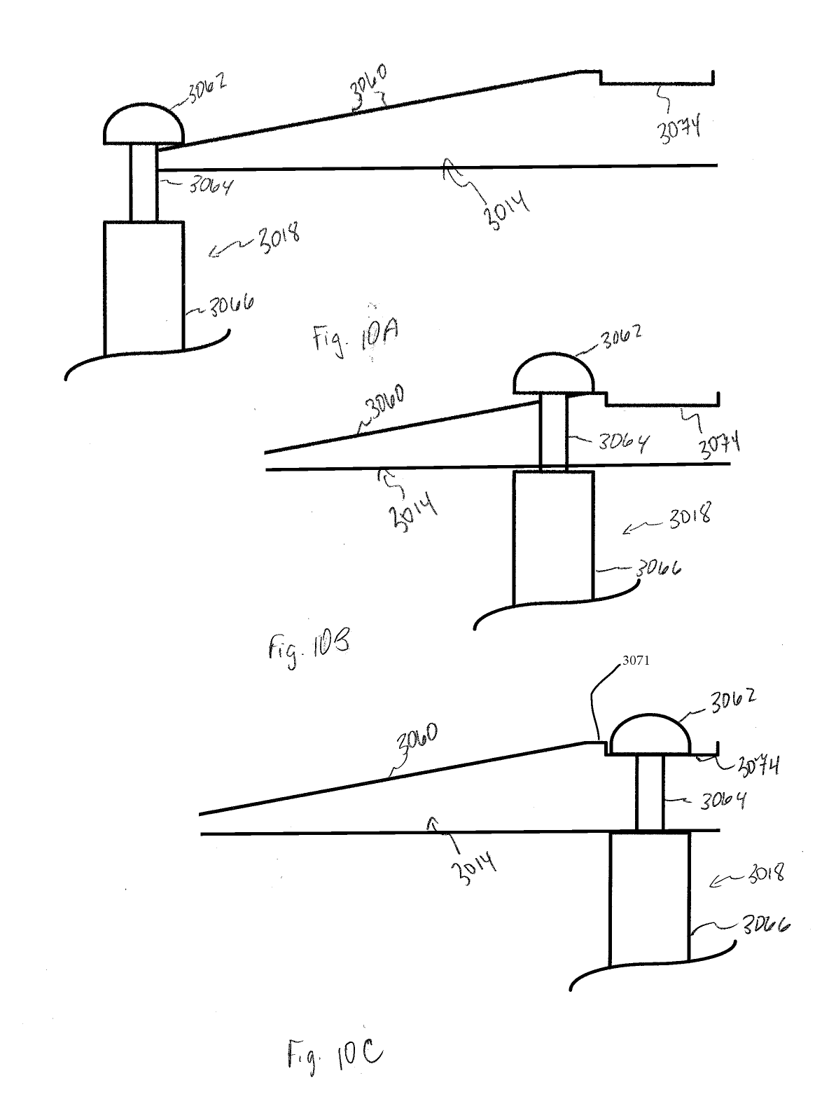

Referring now also to FIG. 8, the door latch 3014 may include a void, hole (or keyhole) 3068 of sufficient size to allow the head 3062 to pass through it when the door latch 3014 is in the open position (keyhole aligned with head of pin) and the door 3004 is closed. The door latch 3014 may also include a slot 3070 that extends away from the hole 3068. The slot 3070 has a width sufficiently large to accommodate the diameter of the neck 3064 (or of the body of the pin, if smaller in diameter than the head), but smaller than the diameter of the head 3062. Thus the head of the post can be captured by the slot as the latch is rotated. The slot 3070 may extend from the hole 3068 and may extend along an straight or curved (e.g. arcuate) path. The door latch 3014 may be rotated about its pivot axis 3072 such that the neck 3064 enters the slot and the head 3062 and remainder of the pin body 3066 are on opposing sides of the door latch 3014. The slot is flanked by a ramp or cam element 3060 of progressively increasing thickness to progressively increase the force required to close the latch with respect to the post head 3062.

When the neck 3064 is within the slot 3070, continued rotation of the door latch 3014 about its pivot axis 3072 causes a portion of bottom of the head 3062 to travel through the slot and contact and ride up a ramp 3060 of a cam feature 3059 as is indicated in the progression of FIGS. 7A and 7B. This ramp feature of the slotted section of the latch causes the door (in which the door latch 3014 is located) to be pulled tightly against the device 3000 as is shown in FIG. 2. Elastomeric components on the inside surface of the door which compress an installed cassette, or in other embodiments along the perimeter of the housing defining the door opening of the device (e.g. on the front plate of the housing), provide sufficient elastic compressibility to permit the door to close tightly as the latch is rotated to a closed position.

In prior devices, slightly before the door latch 3014 reaches its fully closed position (see FIG. 7B), the head 3062 of the latch pin 3018 reaches a terminal, non-ramped section 3071 of the slot 3070 pathway. In prior embodiments, the terminal section 3071 is a flat, non-ramped region located at the same level as the highest point reached by the ramp. Thus, when the door latch 3014 is in the fully closed position, the head 3062 of the latch pin 3018 may be fully on or substantially fully on the terminal section 3071. This terminal section may be considered to be a detent, the thickness (or height) of which helps to hold the door 3004 in the latched or locked position, and helps to avoid a tendency for the ramp 3060 to slide along the latch pin 3018 to move the latch to an open position. In this position, the door 3004 may be held in place against the force of piston element 3032 against the cassette 3022 when the inflatable bladder 3046 is inflated (i.e. when the cassette and cassette receiving area are pressurized). Additionally, this force may make it difficult for a user to open the door latch 3014 during therapy or when otherwise not desired.

Referring now to FIG. 8 and FIG. 9, a specific example embodiment of a prior art door latch 3014 is shown. The example door latch 3014 includes a void, hole or keyhole 3068 and a slot 3070 as described above. The door latch 3014 also includes a cam feature 3059 comprising an incline or ramp 3060 oriented to progressively tighten the latch against the head of the door pin as the latch is moved in a downward (or closing) direction, thus tightening the door against the device housing to which the pin is attached. The width of the ramp 3060 may be approximately equal to, or slightly larger than, the diameter of the head 3062 of the latch pin 3018. The width of the slot 3070 is approximately equal to or slightly larger than the width of the neck 3064 of latch pin 3014. The width of the terminal section 3071 may be similar to that of the ramp 3060, and has a length configured to allow for rotation of the latch slightly past the point at which the door is securely locked in a closed position. The terminal section or detent 3071 is best shown in FIG. 9. The slot 3070, ramp 3060, and terminal section 3071 may preferably be arcuate in shape with respect to the axis of rotation of the latch, but need not have a fixed center of rotation or one coincident with the axis of rotation of the latch. In the example embodiment, these features curve about a substantially constant radius from the pivot axis 3072.

The door latch 3014 may include a handle portion 3080 as well as a latch body portion 3082. The handle portion 3080 may be a relatively thin, elongate projection which extends from the latch body 3082. In some embodiments, a grip member 3084 (see FIG. 1) may be coupled to the handle portion 3080 to facilitate user actuation of the door latch 3014. The grip member 3084 may be coupled to the handle portion at a location distal to the latch body 3082 and may be contoured for ergonomic effect. As shown, the hole 3068, slot 3070, ramp 3060 and terminal section or detent 3071 are all included as features of the latch body 3082.

In a new, improved and more reliable variant of the embodiment of the door latch 3014 described above, a door latch 3014 may include a terminal section comprising a detent having a recessed feature or depression 3074 which may increase the force required to open or close the door, or the degree of difficulty involved in opening the door. As the thickness of the ramp or cam feature flanking the slot increases, the closing force between the door latch or door and the stationary pin or post head increases. The detent may be constructed to have a thickness in the latch body sufficient to maintain a closing force adequate to apply the proper closing force between the door and the housing or post. But the terminal part of the slot (adjacent to the detent feature) may be constructed to have a thickness greater than the detent itself, thus requiring an increased force to disengage the post head from the detent to open the door, or even to engage the post head with the detent to close the door. The barrier (or wall) thus formed between the detent and terminal portion of the slot requires an increased force to make the disengagement.

In various embodiments, it may be more or less desirable to include a door latch 3014 with such a feature depending on various properties of the materials used in the manufacture of the latch. For example, the friction coefficient of the latch material may affect the ease with which a user may be able to disengage the latch when the door is closed and under pressurization. The recessed terminal section 3074 creates a detent release barrier (raised section or wall) that provides enough interference with the head of the pin in relation to the peak height of the ramp to inhibit the latch from being rotated toward an open position with the ramp then moving under the head of the pin. Additionally, using a door latch 3014 including a recessed terminal section or detent may allow for a wide range of acceptable materials with varying surface friction coefficients to be used in the manufacture of the latch. This may allow for the door latch 3014 and/or the door 3004 in which the door latch 3014 resides to be made with materials (such as, e.g., plastics) that may simplify manufacturing processes or reduce manufacturing or assembly costs. It may allow for the door latch 3014 and/or door 3004 to be made of more lightweight materials, more readily available materials, etc. Furthermore, including a recessed terminal section in a door latch 3014 may allow for greater manufacturing tolerances in the production of the latch and door components.

In some embodiments, the new feature (detent release barrier) acts as a mechanical interference that on one hand does not substantially increase the resistance to be overcome to move the latch to an open position when the closed door is not pressurized, but on the other hand greatly increases the resistance to moving the latch to an open position when the door (and an enclosed cassette) have been pressurized by, e.g., a pressure distribution module. In other embodiments, the door latch 3014 and the latch pin 3018 may each include cooperating features which together serve to generate mechanical interference. In the exemplary embodiment, the mechanical interference comprises a recessed detent feature in the terminal section 3074 included in the cam feature 3059 of the door latch 3014.

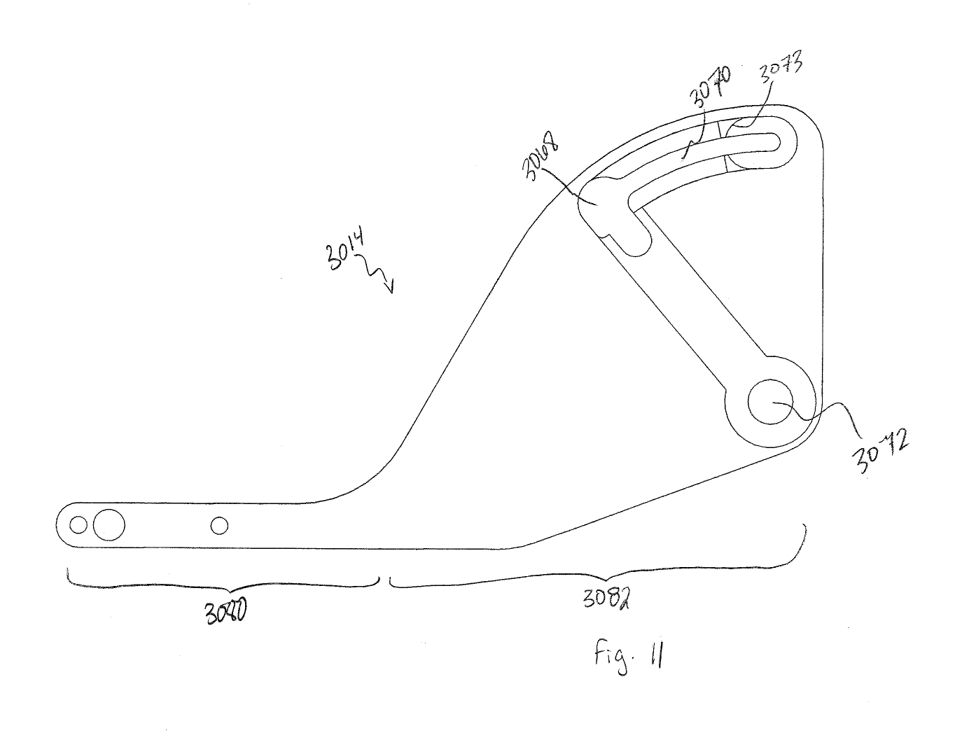

An embodiment of a door latch 3014 including a mechanical interference is representationally depicted in FIGS. 10A-10C. In the example embodiment shown in FIGS. 10A-10C, the door latch 3014 includes a recessed terminal section 3074. The recessed terminal section 3074 may in various embodiments, be appropriately described as a detent, dip, trough, valley, depression, cavity, niche, indentation, nook, notch, gouged out section, socket, and/or cove-like feature. Its surface may be curved or concave, or flat. As shown in FIG. 10C, when the door latch 3014 is actuated to its fully closed position, the latch pin 3018 drops into the recessed terminal section or detent feature 3074 (this is in relative terms; actually the detent of the latch body drops against the undersurface of the stationary head of the pin as the latch is rotated to a closed position). This may help hold the door 3004 in the latched or locked position and avoid a tendency for the latch pin 3018 to slide back down the ramp 3060 when a relatively modest force is applied to the handle portion of the latch. In this position, the door 3004 may be held in place or secured in a closed position against the force of a piston element 3032 against the cassette 3022 when the inflatable bladder 3046 is inflated. Additionally, this force may make it difficult for a user to move the door latch 3014 to an open position during therapy or when otherwise not desired.

Adding a detent release barrier feature 3071 to the terminal section 3074 of the slot of the door latch 3014, as shown, e.g. in FIG. 10C, increases the degree of difficulty or force involved in moving the door latch 3014 to an open position when such an action would be undesired. The door latch 3014 must be rotated with enough force to further compress the door against the cassette or housing perimeter to align the latch pin 3018 with the top of the ramp and out of the detent feature 3074 to move the door latch 3014 to an unlatched or open position. In the example embodiment, such a rotation of the door latch 3014 will cause the door 3004 to be pulled closer to the assembly by a distance substantially equal to the depth of the detent 3074. When the door and cassette receptacle are in a non-pressurized state, the force to be overcome may only comprise the compressibility of an elastomeric gasket or seal on the inside surface of the door or along the perimeter of the portion of the housing defining the door opening. However, when an inflatable bladder in the assembly is inflated (or when another type of force generator is actuated) and exerting an opening force against the door 3004, the force generated by the inflatable bladder must be overcome to rotate the door latch 3014 such that the latch pin 3018 exits the detent portion 3074. Thus, the force required and the degree of difficulty involved in opening the door latch 3014 is magnified. A detent barrier feature of the terminal section of the latch slot thus achieves a remarkable effect of improving the prevention of unintended or improper opening of the door when pressurized, while still permitting the door to be opened with relative ease when not pressurized.

In testing, a prototype latch having a detent release barrier (i.e., a recessed detent region, or a raised terminal ramp region relative to the detent) was found to provide the necessary mechanical resistance or interference required by the following example requirement. The door was specified to remain latched when up to about 53 newtons of force is applied at a specified location on the handle of the latch member, when about 850-925 newtons of force is being applied on the door piston by the door bladder to keep the door firmly pressed against the front plate of the housing (or against an installed cassette). In the absence of the detent release barrier, the requirement failed because forces of between 40-50 newtons caused the latch to be released and the door to open. In the presence of the detent release barrier, forces of between 127 and 146 newtons were needed to move the latch contact with the post head from the detent region to the ramped or cammed slot region, allowing the door to be opened. Note that under this arrangement, no additional force is needed to move the latch detent onto the post head from an open position, because the door bladder and piston are not generating any force at that time. Thus the goal of preventing accidental or improper door opening when the door is closed and the system is operating can be achieved, the required opening force having been substantially raised by the presence of the detent release barrier (e.g., recessed detent or raised terminal ramp feature).

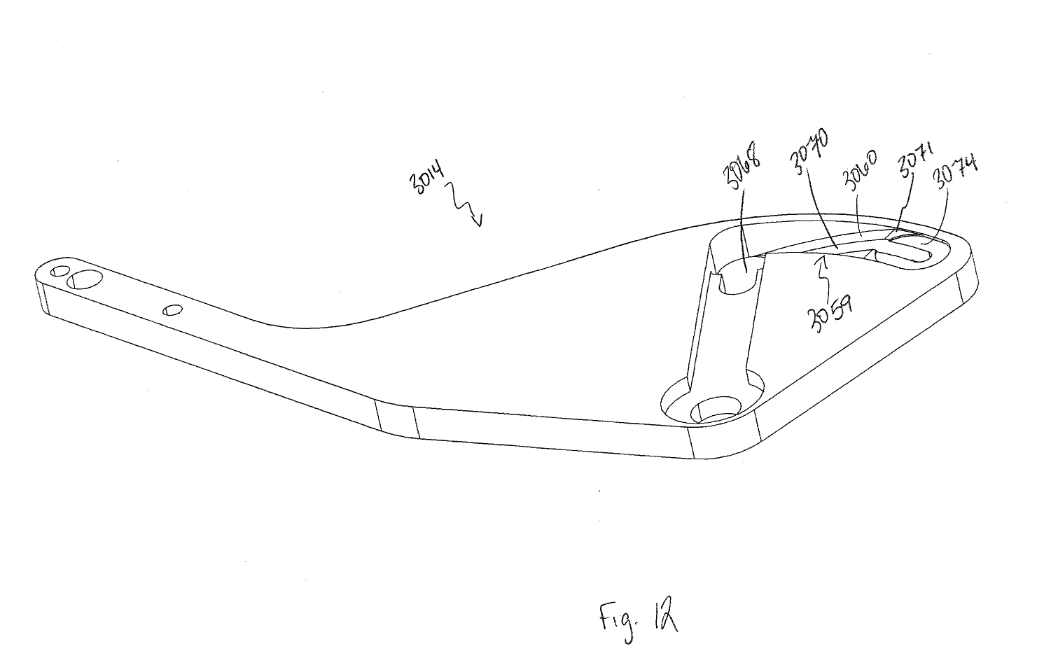

Referring now to FIG. 11 and FIG. 12, a specific example embodiment of a door latch 3014 is shown. The example door latch 3014 includes a void, hole or keyhole 3068 and a slot 3070 as described above. The door latch 3014 also includes a cam feature 3059 including an incline feature or a ramp 3060. The width of the ramp 3060 may be approximately equal to, or slightly greater than, the diameter of the head 3062 of the latch pin 3018. The width of the detent feature of the terminal section 3074 of the slot may also be approximately equal to the diameter of the head 3062 of the latch pin 3018. The detent feature 3074 is best shown in FIG. 12. The slot 3070, ramp 3060, and recessed terminal portion 3074 may be arcuate in shape with respect to the axis of rotation of the latch. In the example embodiment, these elements curve about a substantially constant radius from the pivot axis 3072, although the arcuate path need not have a fixed radius or have an axis of rotation coincident with the axis of rotation of the latch body. As in the example embodiment, there may optionally be a transitional region 3071 (best shown in FIG. 12) between the ramp 3060 and the detent portion 3074 which may simplify manufacturing tolerances, and preserve the desired effect of the selected detent depth.

The door latch 3014 may include an elongate handle portion 3080 as well as a latch body portion 3082. In some embodiments, a grip member 3084 (see FIG. 1) may be coupled to the handle portion 3080 to facilitate user actuation of the door latch 3014. As shown, the void 3068, slot 3070, ramp 3060 and detent feature 3074 all comprise features of the latch body 3082.

In the specific example, the detent feature 3074 may be sized such that it may accommodate the head 3062 of the latch pin 3018. In the example embodiment, the ramp 3060 of the cam feature 3059 optionally levels out for a relatively short flat transitional region 3071 before the recessed detent 3074 begins. Additionally, the wall 3073 of the detent barrier feature 3074 closest to the ramp 3060 can be roughly perpendicular or at an angle to the floor of the detent feature. This wall may be curved to match the contour of the side of the head 3062 of the latch pin 3018. In an example embodiment (as shown), the wall of the detent feature has an approximately semi-circular concave shape, which allows the head of the engaged pin to begin to breach the detent barrier with reduced stress on the latch body or connected components. In other embodiments, the wall of the detent feature may instead be straight or have another shape, depending on the degree of interference desired between the head of the latch pin and the terminal part of the ramp. In some embodiments, this wall 3073 may be radiused or ramp-like so as to afford an easier transition out of the detent feature 3074 when the door latch 3014 is moved to an unlatched position. In other embodiments, the wall 3073 of the detent feature 3074 may include an undercut which is configured to accept a cooperating feature on the head 3062 of the latch pin or post 3018 in order to make the transition out of the detent 3074 more or less difficult. In a particular example, the detent feature 3074 may be recessed approximately 0.008″-0.020″ (e.g., about 0.012″) from the top of the ramp 3060. In other embodiments, the detent feature 3074 may be recessed to a greater or lesser degree. Additionally, though the depth or floor of the detent feature 3074 is shown to have a substantially flat surface, in other embodiments, it may be curved, concave or comprise angled inclines, depending again on the desired degree of interference between the head of the latch pin and the top of the ramp of the slot.

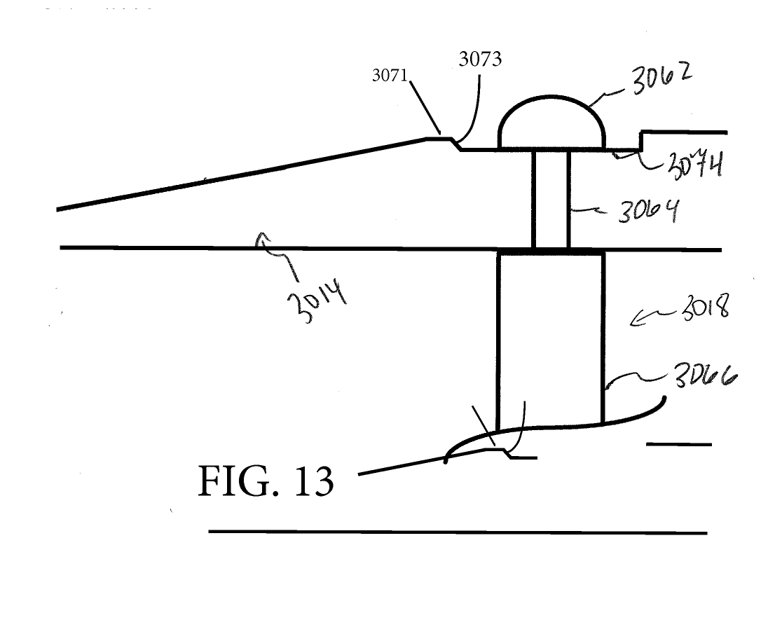

In an example shown in FIG. 13, the wall 3073 of the detent release barrier is somewhat sloped to ease the movement of the detent 3074 against the post head 3062 to the terminal portion 3071 of the ramp 3014 of the slot. Thus, the slope of the wall 3073—which can be straight or curved—together with the height or thickness of the wall 3073 can be adjusted to achieve the desired release force for the post head 3062, while also ensuring minimal wear and tear on the components when that force is actually applied.

As shown best in FIG. 11, the detent feature 3074 of the door latch 3014 has a length or span which is longer than the diameter of the head 3062 of the latch pin 3018. It may be desirable to allow some degree of travel between the head of the latch pin and the terminal section when latching the door of a device. The length of the detent portion 3074 may be selected to allow for a desired amount of acceptable under travel. This may allow the door latch 3014 to be fully engaged before the door latch 3014 has been rotated fully to the locked position. An elongated detent portion 3074 may also be desirable in certain embodiments in which a sensor is used to detect that a door has been closed or latched. The additional travel of the latch body after full engagement may help to ensure that any sensor used to detect door closure and latching does so only after the latch reaches the end of its travel, well after the latch is fully engaged. And if the user fails to fully rotate the door latch 3014 to the terminal latched position, the door may still achieve a latched position. Including an elongated detent 3074 as in FIG. 11 and FIG. 12, may help to ensure that the latch pin or post 3018 is seated in the detent portion of the terminal section 3074 even in the event of a premature detection of a fully latched condition by the sensor.

Various alternatives and modifications can be devised by those skilled in the art without departing from or diminishing the innovations disclosed herein. While several embodiments of the present disclosure have been shown in the drawings and/or discussed herein, it is not intended that the disclosure be so limited. Therefore, the above description should not be construed as limiting, but merely as examples of particular embodiments.

In the drawings, for illustrative purposes, the relative sizes of some of the elements, or their actual dimension, may be exaggerated and not drawn to a particular scale. Additionally, elements shown within the drawings that have the same numbers may be identical elements or may be analogous elements, depending on the context.

1. A door latch comprising:
a latch body pivotally connected to a door that is hingedly attached to a housing;
the latch body configured to rotate about an axis perpendicular to a face of the door;
the latch body comprising a hole having a first width through which a post attached to the housing penetrates as the door is closed;
the latch body comprising an elongated slot having a first end and a second end, the slot having a second width smaller than the first width of the hole, and extending from the first end at the hole to the second end, so that rotation of the latch body about its axis to a closing position moves the slot relative to the post from the first end to the second end;
the post having a head sized larger than a neck or body of the post, the head being smaller than the first width of the hole but larger than the second width of the slot, so that the post head is captured by the slot as the latch body rotates to the closing position;
the slot flanked by a ramp or cam element on the latch body that provides a closing force between the door and the post as the latch body is rotated to the closing position, the ramp or cam element having a first thickness at the first end of the slot, progressing to a greater terminal thickness at the second end of the slot;
the second end of the slot terminating at a slotted detent having a thickness that provides a first maintenance force between the door and the post when the detent is rotated onto the head of the post;
wherein the terminal thickness of the ramp or cam element at the second end of the slot is greater than the thickness of the detent, thereby requiring a release force between the door and the post that is greater than the maintenance force in order to rotate the detent onto or off the head of the post.

2. The door latch of claim 1, wherein the thickness of a portion of the detent increases to the terminal thickness of the ramp or cam element in a graduated slope.

3. The door latch of claim 2, wherein the graduated slope is straight or curved.

4. The door latch of claim 1, wherein the slot defines a curved or arcuate path upon rotation of the latch body.

5. The door latch of claim 4, wherein the curved or arcuate path defines a rotation about a fixed radius extending to the axis of rotation of the latch body.

6. The door latch of claim 1, wherein the latch body comprises a latch handle by which a user can rotate the latch body to the closing position or to an open position.

7. The door latch of claim 1, wherein at least a portion of the head of the post has a rounded, conical or triangular shape to facilitate penetration of the head of the post through the hole of the latch body.

8. A door closing system for a medical device comprising:
a rotatable latch mounted to a door hingedly connected to a housing of the medical device, so that the axis of rotation of the latch is generally perpendicular to the face of the door;
a post fixed to the housing of the medical device and facing an inner side of the door as the door is closed;
the post configured to penetrate a hole in the latch upon closure of the door;
the latch comprising an elongated slot extending from the hole to a slotted detent of the latch;
a head of the post sized to penetrate the hole, but larger than a width of the slot;
a neck or body of the post being sized to pass through the slot, so that the head of the post can be captured by the slot as the latch is rotated from an open position to a closing position;
the slot being flanked by a ramp or cam element on the latch that provides a closing force between the door and the post as the latch body is rotated to the closing position;
the ramp or cam element having a first thickness at the first end of the slot, progressing to a greater terminal thickness at the second end of the slot;
the second end of the slot terminating at a slotted detent having a thickness that provides a maintenance force between the door and the head of the post when the detent is rotated onto the head of the post;
wherein the terminal thickness of the ramp or cam element at the second end of the slot is greater than the thickness of the detent, thereby requiring a release force between the door and the post that is greater than the maintenance force in order to rotate the detent onto or off the head of the post.

9. The system of claim 8, wherein a difference between the maintenance force and the release force is increased when the door is pressed in a closed position against the housing.

10. The system of claim 9, wherein a piston in the door of the medical device is configured to apply pressure to the closed door when the latch detent is positioned against the head of the post.

11. The system of claim 10, wherein the piston is actuated by an inflatable bladder in the door and behind the piston.

12. The system of any one of claims 8-11, wherein the medical device comprises a peritoneal dialysis cycler.

13. The system of claim 8, wherein the thickness of a portion of the detent increases to the terminal thickness of the ramp or cam element in a graduated slope.

14. The system of claim 13, wherein the graduated slope is straight or curved.

15. The system of claim 8, wherein the slot defines a curved or arcuate path upon rotation of the latch.

16. The system of claim 15, wherein the curved or arcuate path defines a rotation about a fixed radius extending to the axis of rotation of the latch.

17. The system of claim 8, wherein the latch comprises a latch handle by which a user can rotate the latch to the closing position or to an open position.

18. The system of claim 8, wherein at least a portion of the head of the post has a rounded, conical or triangular shape to facilitate penetration of the head of the post through the hole of the latch body.
